(19) United States
(12) Patent Application Publication
(10) Pub. No.: US 2023/0257840 A1
(43) Pub. Date: Aug. 17, 2023

(54) METHOD FOR LASER HARDENING A SUBSTANTIALLY CYLINDRICAL SURFACE OF A WORKPIECE

(71) Applicant: Johann FIMBINGER, Kalsdorf (AT)

(72) Inventor: Johann FIMBINGER, Kalsdorf (AT)

(21) Appl. No.: 18/137,816

(22) Filed: Apr. 21, 2023

Related U.S. Application Data
(63) Continuation of application No. PCT/EP2021/070010, filed on Jul. 16, 2021.

(30) Foreign Application Priority Data
Oct. 23, 2020 (DE) 10 2020 127 991.4

(51) Int. Cl. C21D 1/09; B23K 26/082; B23K 26/352

(52) U.S. Cl. CPC C21D 1/09; B23K 26/082; B23K 26/352

(57) ABSTRACT

A method is provided for laser hardening a substantially cylindrical surface of a workpiece, e.g. the wheel rim of the wheel disk of a track-guided railway wheel, at least with a partial width of its wheel tread and/or of the side of its flange facing the wheel tread, which are subjected to abrasion. The method includes projecting a laser spot, by means of a laser source, onto the surface of the wheel disk which is to be processed, producing relative movement between the surface and the laser source by rotating the wheel disk about its axis of rotation, scanning the laser beam with respect to the surface which is to be processed, during the rotational movement, and modulating the laser beam in accordance with various criteria, for example with respect to its power and/or its scanning speed and/or its laser spot size and/or its scanning pattern.

### CROSS REFERENCE TO RELATED APPLICATIONS

This application is a continuation under 35 U.S.C. §120 of International Application PCT/EP2021/070010, filed Jul. 16, 2021, which claims priority to German Application No. 10 2020 127 991.4, filed Oct. 23, 2020, the contents of each of which are incorporated by reference herein.

### FIELD OF THE INVENTION

The invention relates to a method for laser hardening of a substantially cylindrical surface of a workpiece such as the wheel rim of the wheel disk of a track-guided railroad wheel, at least in a partial width of its tread exposed to abrasion and/or in the side of its wheel flange facing the tread.

Similarly, the invention relates to any workpieces having laser-hardenable cylindrical surfaces, such as, for example, sections of railroad wheelset shafts, journals of crankshafts or the like.

The invention further relates to an apparatus for laser hardening of the wheel rim of a track-guided railroad wheel with tread and wheel flange for guiding the railroad wheel on the track, as well as a railroad wheel manufactured according to the foregoing method with the apparatus mentioned in the foregoing.

### BACKGROUND

Treads of rail-vehicle wheels, such as the wheel disks on railroad cars and railroad locomotives, are subject to more or less severe wear as a result of friction or slip between wheel and rail, depending on material pairing, material composition and surface hardness of wheel disk and track rail, as well as on the environmental conditions. This wear limits the service life of the wheels. Accordingly, the running times between two maintenance cycles may vary greatly, so that significant fluctuations in the cost of maintenance are to be expected for repeated profiling of the wheel disks at or shortly before the specified operational limit dimensions are reached.

In order to reduce the said wear, railroad wheels have been manufactured with thermally hardened treads, wherein usually the entire wheel flange has been hardened. Because of the danger, in the region of the wheel flange, of cracking associated with such thermal hardening, and for improvement of the hardening, it was proposed according to EP 0116359 that railroad wheels be manufactured in which the portions of the tread and/or of the part of the wheel flange facing it are laser-hardened in circumferential direction. In the process, depth and extent of the lasered sections may be varied within wide limits. According to the known proposal, laser hardening may be carried out together with turning or stripping of the wheel rim. For control of the degree of hardening, the distance between the laser-hardening apparatus and the surface to be hardened may be varied in that process.

In the use of laser hardening described in WO99/29520, strips having martensitic crystal structure and extending obliquely relative to the direction of travel are generated by means of the laser beam at distances transverse relative to the tread of a wheel disk of a track-guided railroad wheel. Due to the increased hardness of these strips, noise and vibrations of the driving operation are supposed to be reduced.

According to DE 10218141 A1, it is proposed as a variant of a laser heat treatment of workpieces that the workpiece be acted on by several laser-beam bundles, which can be respectively controlled separately, by means of relative movement between these and the workpiece.

For use of at least two of such laser-beam bundles, these may be moved relative to one another, along a circular path, for example, starting from a common start line until they meet in a common end line. Upon reaching the common end line, exact movement control is desired in order to avoid overlapping of the hardening paths, and in this connection it is additionally possible to reduce the intensity of the two laser-beam bundles meeting one another. In this way, the danger of locally undesired heat input at annealing temperature is supposed to be prevented.

Finally, from DE 112013004368 T5, a method is known for laser hardening of a surface of a journal of a crankshaft, wherein a surface region to be hardened comprises at least one partial region that is more heat-sensitive and one partial region that is less heat-sensitive. According to that method, the laser beam is scanned in such a way that the two surface regions are heated with different intensity by different modulation of the laser beam. In this way, regions of the crankshaft adjoining an oil lubrication hole are exposed to less heat input than other surface regions of the crankshaft.

In contrast, an object underlying the present invention is to achieve a surface, generated by laser hardening, of wheel rims on railroad wheels that reduces wear between wheel disk and track even under difficult environmental conditions and thus permits longer running times between two maintenance cycles. One particular objective in this regard consists in that all surface regions exposed to abrasion can be machined uniformly both on sides of the wheel flange and on the wheel tread adjoining them, so that especially wear-related abrasion that varies over the said wheel disk circumference can be avoided.

In particular, influencing variables that are harmful in this regard, such as disturbing micro-vibrations between wheel disk and track, and that may cause out-of-roundness of the wheel disk during driving operation, are supposed to be avoided by suitable modulation of the laser beam with creation of a uniform hardness/depth profile of the laser hardening path.

### SUMMARY

Starting from the prior art mentioned in the introduction, an embodiment of the inventive method comprises the steps of:
projecting, by means of a laser source, a laser spot onto the surface of the wheel disk to be machined
generating a relative movement between the surface and the laser source by rotating the wheel disk around its axis of rotation,
during the rotational movement, scanning of the laser beam with respect to the surface to be machined and
modulating the laser beam according to various criteria such as, in particular, with regard to power and/or its scanning speed and/or its laser-spot size and/or its scanning pattern,
wherein the laser spot describes a scanning pattern in the manner of a narrow line shape transverse relative to the surface to be machined, corresponding to the rotation of the wheel disk and extending over its entire width, wherein the line shape of the scanning pattern extends with its longitudinal axis obliquely relative to the axis of rotation of the wheel disk.

In the process, additional influencing variables are to be considered, such as the composition of the wheel-disk material according to DIN EN 13262, surface condition such as roughness, degree of oxidation, homogeneity of the wheel-disk material, ambient temperature, etc.

Due to the inventive feature that the laser spot describes a scanning pattern in the manner of a narrow line shape transverse relative to the surface to be machined, corresponding to the rotation of the wheel disk and extending over its entire width, it is possible to work with particularly short laser process times, so that a pronounced temperature gradient can be achieved in the depth of the wheel rim due to the heat input at the surface.

Due to the further inventive feature that the line shape of the scanning pattern extends with its longitudinal axis obliquely relative to the axis of rotation of the wheel disk, it is possible largely to avoid vertical micro-vibrations, which may lead to more intensive vibrations within the contact contour between wheel disk and track. To the contrary, a uniform hardness buildup and a homogeneous hardness distribution within the laser trajectory are achieved due to the obliqueness of the laser spot.

By avoiding the said micro-vibrations, which may lead to out-of-roundness of the wheel disk and thus to disturbances in the wheel-rail contact, it is possible to extend the service life of a wheel disk between successive maintenance dates significantly, with the consequence of considerable cost savings.

Advantageously, the obliqueness of the line shape of the laser spot with respect to a plane perpendicular to the axis of rotation of the wheel disk extends within an angular range between 30 and 60 angular degrees, in such a way that the laser spot ends correspondingly obliquely at the opposite edges of the surface to be machined. In this regard, it is advantageous, for avoidance of unevennesses of the hardness distribution close to the edges, for the scanning pattern of the laser spot to end respectively with a rounded portion at the edges.

In a further configuration of the invention, it is provided that the laser source is operated with reduced power after at least one first full revolution of the wheel disk within an overlap zone adjoining the beginning and/or end of the machined surface. In this regard, the laser spot within the overlap zone is advantageously modulated such that its power increases toward the beginning of a revolution and decreases toward its end. In the process, the laser-treated surface of the wheel disk exposed to abrasion is configured particularly uniformly in the transition regions of each overlap zone.

In one advantageous configuration, the width of the overlap zone in a railroad wheel is approximately between ¼ and ⅛ of the track width of the treated surface, advantageously approximately ⅙ of the track width.

In an embodiment with at least two full revolutions, a first for laser hardening, the second for laser tempering, the set object is achieved in particularly complete manner, because thereby it is possible to realize the edge hardnesses and their hardening depths desired for conventional wheel-disk materials without restriction.

In this regard, it is the case, according to a further proposal of the invention, that the first full revolution for laser hardening takes place with laser modulation suitable for generating an edge hardness > 600 HV, followed by a second full revolution for laser tempering, plus an overlap zone with laser modulation suitable for generating an edge hardness between 380 and 430 HV (see diagram according to FIG. 4).

To achieve long service lives, a further configuration of the invention consists in that, for laser tempering, the laser modulation is suitably controlled to generate a maximum hardness depth between 0.5 and 2.0 mm (see diagram according to FIG. 4).

According to a further inventive proposal, a mechanical pretreatment of the surface to be machined is provided in such a way that an oxide layer present on the wheel rim is mechanically removed before the first revolution of the wheel disk for laser hardening and/or after each further revolution of the wheel disk for laser tempering. Otherwise, the danger exists of the development of local temperature peaks, which may lead to automatic governing of the laser power and to soft spots (during hardening) or to hard spots (during tempering).

Finally, according to embodiments of the invention, an apparatus suitable for laser hardening of the wheel rim of a track-guided railroad wheel with tread and wheel flange for guiding the railroad wheel on the track is provided, which comprises:
an underfloor lathe with a clamping jig for maintenance of wheel disks on railroad wheel sets,
wherein a laser source is associated with the clamping jig and is disposed opposite a wheel disk to be machined in such a way that the laser beam generates a laser spot on its tread and/or wheel flange,
wherein the laser source has a scanning device for scanning the laser beam in order to ensure a constant distance between the surface of the wheel disk to be machined by the laser beam and the laser source during a rotation of the wheel disk around its axis of rotation, and
wherein a control unit is provided that comprises a data memory with control data for modulating the laser beam.

The embodiment of the inventive apparatus makes it possible to machine the guide faces of the wheel disks mechanically without removing them in the course of normal maintenance of railroad wheelsets and to carry out the laser heat treatment in direct connection therewith.

In a further configuration of the inventive apparatus, it is provided that the data memory comprises rotation-related data sets of control data for modulation of the laser beam, such as, in particular
power of the laser beam
power distribution within the laser beam
laser focal width
scanning speed
scanning pattern of the laser spot
laser process time.

In this connection, still further control data can be adjusted, such as for the angular position of the laser beam or for its power distribution within the laser spot.

The result is a railroad wheel without precedent, i.e. with the technical characteristics on the basis of its manufacture according to the inventive method, according to which the tread and wheel flange of which are hardened over the full circumference at least in a partial width of tread and/or wheel flange by laser heat treatment, wherein the treated surface comprises, at its beginning and its end as well as after each full wheel revolution, a narrow overlap zone with reduced laser power, wherein the width of the overlap zone is expediently approximately ⅙ of the track width of the treated surface.

### BRIEF DESCRIPTION OF THE DRAWING

The invention will be explained in the following by way of example on the basis of the drawing. In its figures,

FIG. 1 shows a partial cross section through the profile of the wheel disk of a railroad wheel

FIG. 2 shows a schematic diagram of a laser spot on a tread, to be machined, of the wheel disk

FIG. 3 shows a wheel-rail contact diagram with Hertzian contact face and

FIG. 4 shows a diagram of a hardness-depth profile of a laser track after laser hardening and laser tempering.

### DETAILED DESCRIPTION OF THE PREFERRED EMBODIMENTS

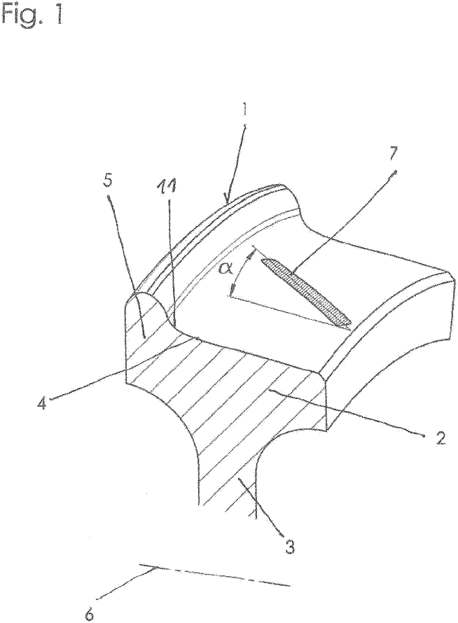

FIG. 1 shows a partial cross section of a wheel disk 1 of a railroad wheel through its axis of rotation. The partial section passes through wheel rim 2 of wheel disk 1. A short length of web 3 of wheel disk 1 extending to the hub is illustrated in the region of its transition to wheel rim 2. Tread 4 of wheel disk 1 extends along the outer circumference of wheel rim 2, and in radial direction transitions via a rounded portion 11 to the lateral guide face of wheel flange 5. Axis of rotation 6 of wheel disk 1 of the railroad wheel or of the corresponding wheelset is shown at a distance shortened relative to scale.

On tread 4, extending obliquely at an angle α with respect to an axial section plane, laser spot 7 is illustrated as a narrow line shape rounded at the opposite ends. This means that, while wheel disk 1 is revolving, laser spot 7 is aligned such that its longitudinal axis is oriented correspondingly obliquely at angle α relative to axis of rotation 6, and it maintains this alignment during the rotation of wheel disk 1.

Depending on requirement for the hardness of the surface to be machined, the process of laser hardening may be different for railroad treads on sides of the wheel disk.

On the one hand, the possibility exists of pure laser hardening to achieve particularly high degrees of hardness; on the other hand – preferably for European applications – combinations of the actual hardening process with a subsequent process of laser annealing come into consideration, wherein the process parameters are entirely different.

Whereas the hardening temperature on the surface to be machined is approximately 1150° C., the tempering temperature is much lower, at approximately 530° C.

Whereas the feed rate is approximately 100 mm / min for laser hardening, corresponding to the rotation of the wheel disk, it is significantly slower for the tempering process, namely approximately 70 mm / min.

Even for laser power, the values for starting the process diverge, namely at approximately 6 kW for the hardening process and at approximately 5 kW for the tempering process. Thus greatly differing values are obtained during these process sequences by corresponding regulating adjustments.

As mentioned above, as far as the two process variants of laser hardening and/or laser annealing are concerned, the laser hardening method according to the application is subject to different requirements for the surface of the laser track.

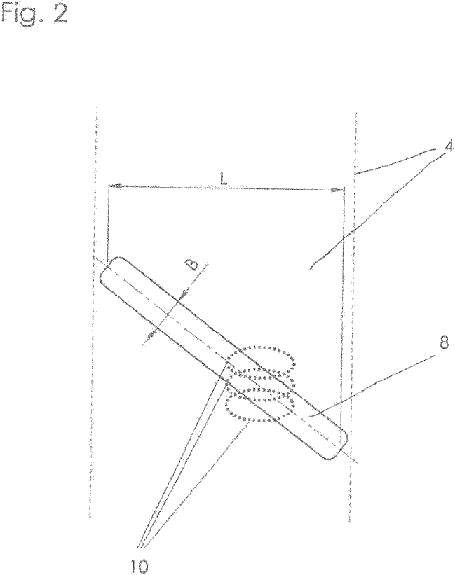

Due to the oblique orientation of laser spot 7 described in the foregoing, it is possible, as shown in FIG. 2, to influence the starting and ending phases of a laser track for successive process phases in such a way that a most even transition possible at the beginning and end of each full revolution of wheel disk 1 is ensured under the action of the laser spot.

In addition, due to the oblique orientation of laser spot 7, it is possible to use an overlap zone 8 with adapted, e.g. lower, surface hardness at the beginning and end of each full revolution of the treated wheel disk 1, thus permitting smooth rolling at the track-rail contact. The reason for this is the extensive avoidance of micro-vibrations in the laser-treated surface. Such micro-vibrations otherwise generate increasing out-of-roundness as a consequence of vertical dynamics within the track-rail contact.

The influence of an overlap zone is favored by the process of laser annealing, because the resulting lower hardness of the tread at the track-rail contact permits damped rolling.

The representation of an overlap zone 8 according to FIG. 2 corresponds approximately to the scale of 1:1 for a width of tread 4 of approximately 60 mm. Such an overlap zone 8 with width B and length L is provided respectively before the beginning of the laser trajectory and after its end. The drawing shows, in three phases, the elliptical contour 10 of the Hertzian wheel-rail contact for finely graduated bridging in the region of the overlap zones of the laser trajectory, whereby the harmful vibrations that occur to a greater extent in the known laser spots extending transversely relative to the track are largely avoided.

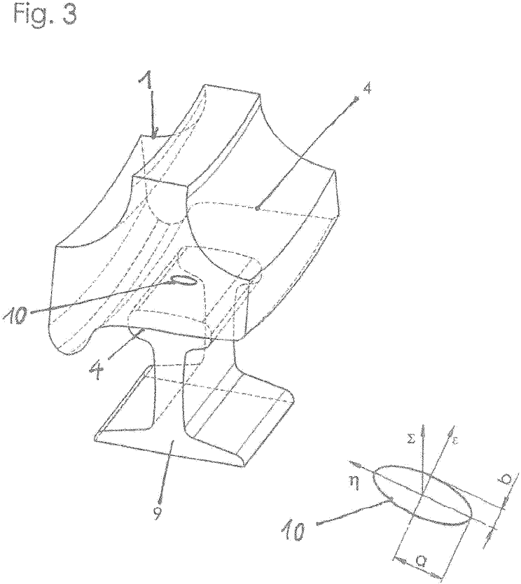

With regard to the Hertzian contact face, see FIG. 3, which shows a schematic diagram of the partial circumference of a tread 4 of a wheel disk 1 on a rail section 9 of a railroad track. Hertzian contact face 10 shown on the track corresponds to the wheel-rail contact, i.e. at the contact point the axes (η, ε, ∑) of the contact systems of wheel and rail coincide to form the elliptical Hertzian contact face 10 illustrated separately in FIG. 3 with the semi-axes a and b, wherein the shorter semi-axis b is aligned in the direction of travel.

In the following, results obtained from preliminary tests and pertaining to the method according to the application are explained. In this case, the results of laser hardening in the generation of a circumferential hardening path of a railroad wheel are optionally treated by the process of pure laser hardening in a first wheel revolution or of laser hardening in a first wheel revolution and subsequent laser tempering in a further wheel revolution. What is essential here is the modulation of the laser beam with respect to its power and/or its scanning speed and/or its laser-spot size and/or its scanning pattern and/or the laser process time.

The treads of wheel disks on railroad locomotives and cars are subject to wear phenomena of different intensity depending on the surface hardness of the wheel disk and rail as well as on prevailing environmental conditions. In the Arab world, for example, the action of sand as an abrasive medium at, moreover, high temperatures, represents an extreme challenge in terms of material wear, so that the running times between two maintenance cycles of the wheel disks on railroad wheelsets are correspondingly short there and lead to high operating costs.

Series of tests were carried out with one- or two-stage laser heat treatment with the goal of achieving an edge hardness, i.e. a maximum hardness at a hardening depth of between 0.5 and 2.0 mm, wherein a hardening path width of approximately 60 mm was specified.

Furthermore, a narrow line-shaped laser spot was selected, approximately in the form of a slender stripe profile with a ratio of its length to its width of between 50 and 30, preferably of approximately 40.

For the following description of the results, laser heat treatment was applied in two process phases, comprising a first wheel revolution after the process of laser hardening and/or a subsequent further wheel revolution after the process of laser tempering. In this process, an oxide layer from the first laser process was mechanically removed to ensure stable process control during laser annealing.

Moreover, in conformity with the present invention, machining in both process phases was carried out with an oblique alignment of the laser spot relative to the axis of rotation and, above and beyond that, an overlap zone with reduced laser power was applied at the beginning and at the end of each full revolution in both laser processes.

As regards hardware, the preliminary tests were carried out with a 6 kW high-power diode laser having an optical fiber diameter of 1500 µm, wherein a standard focusing optical system with a focal diameter of 15 mm was used.

A suitable scanner optical system – known under the LASSY brand – was used to set a uniform temperature field and to control the laser focal width.

A suitable thermal imaging camera was used as the process controller, namely
for the hardening process: Standard E-MAQS with LompocPro control software as well as
for the tempering process: same standard, but for low-temperature range.

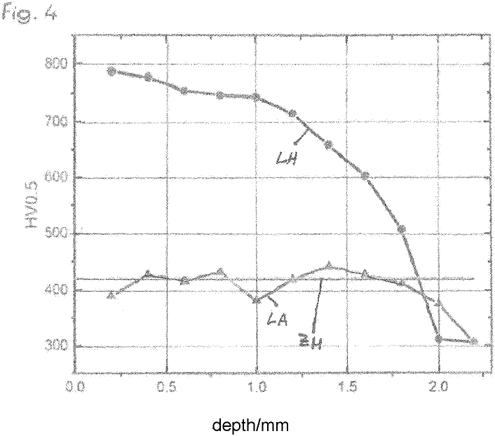

The result is illustrated in the diagram according to FIG. 4, where the abscissa shows the depth in mm and the ordinate the hardness depth in units of HV0.5.

In this diagram, the upper curve LH signifies the variation of maximum hardening for the laser hardening process, as does the lower curve LA for the tempering process. Its target hardness is indicated by the straight line ZH at 420 HV0.5.

The tempering curve LA describes the attainment of the target specification ZH.

A pronounced temperature gradient into the depth is induced by the two-stage heat input to the surface. At both hardness levels (see curves LH and LA), a short laser process time of only nine seconds per revolution was used - without pre- and post-processing time within the overlap zones.

From the hardness/depth variations shown in FIG. 4, a pronounced temperature gradient in depth can be deduced, which is decisively influenced by the heat input at the surface by means of the narrow line-shaped laser spot, the short laser process time of approximately 9 seconds and the homogeneity of the material microstructure of the wheel rim.

As far as the tempering parameters are concerned, it has been found that very precise tuning is to be respected here in terms of optimum tempering temperature and exposure time, in order to achieve the illustrated uniform hardness/depth curve according to tempering curve LA. In particular, it has been shown that small temperature deviations of 10 to 20 degrees Kelvin already lead to clearly measurable effects, which may lead to deviations from a uniform distribution within the hardening zone, i.e. precise beam shaping during laser spot modulation is to be respected.

What is claimed is:

1. A method for laser hardening of a substantially cylindrical surface of a workpiece, especially a wheel rim (2) of the wheel disk (1) of a track-guided railroad wheel, at least in a partial width of its tread (4) exposed to abrasion and/or of the side of its wheel flange (5) facing the tread (4), comprising the following method steps:
projecting a laser spot (7) by means of a laser source onto the surface of the wheel disk (1) to be machined,
generating a relative movement between the surface and the laser source by rotating the wheel disk (1) around its axis of rotation,
during the rotational movement, scanning of the laser beam with respect to the surface to be machined,
modulating the laser beam according to various criteria such as with regard to its power and/or its scanning speed and/or its laser-spot size and/or its scanning pattern,
wherein the laser spot (7) describes a scanning pattern in the manner of a narrow line shape transverse relative to the surface to be machined, corresponding to the rotation of the wheel disk (1) and extending over its entire width, wherein the line shape of the scanning pattern extends with its longitudinal axis obliquely relative to the axis of rotation (6) of the wheel disk (1).

2. (canceled)

3. (canceled)

4. The method of claim 1, wherein the longitudinal axis of the line shape forming the laser spot (7) forms, relative to a plane perpendicular to the axis of rotation (6) of the wheel disk (1), an angle α between 30 and 60 degrees, in such a way that the laser spot (7) ends correspondingly obliquely at the opposite edges of the surface to be machined.

5. The method of claim 4, wherein the scanning pattern of the laser spot (7) ends respectively with a rounded portion at the edges.

6. The method of claim 1, wherein the laser source is operated with reduced power after at least one first full revolution of the wheel disk (1) within an overlap zone (8) adjoining the beginning and/or the end of the machined surface.

7. The method of claim 6, wherein the laser spot (7) within the overlap zone (8) is modulated such that its power increases toward the beginning of a revolution and decreases toward its end.

8. The method of laser hardening of claim 1, wherein at least two full revolutions of the wheel disk (1), a first for laser hardening, the second for laser tempering, are carried out.

9. The method of laser hardening of claim 8, wherein the first full revolution for laser hardening takes place with laser modulation suitable for generating an edge hardness > 600 HV, followed by a second full revolution for laser tempering with laser modulation suitable for generating an edge hardness between 380 and 430 HV.

10. The method of laser hardening of claim 9, wherein for laser tempering, the laser modulation is suitably controlled for generation of a maximum hardness depth between 0.5 and 2.0 mm.

11. The method of laser hardening of claim 8, wherein before the first and/or after each further revolution of the wheel disk (1), an oxide layer present on the wheel rim (2) or formed after a previous laser treatment is mechanically removed.

12. An apparatus for laser hardening of the wheel rim of a track-guided railroad wheel with tread (4) and wheel flange (5) for guiding the railroad wheel on the track, wherein the apparatus comprises:
an underfloor lathe with a clamping jig for maintenance of the wheel disks (1) on railroad wheelsets,
wherein a laser source is associated with the clamping jig and is disposed opposite a wheel disk (1) to be machined in such a way that the laser beam generates a laser spot (7) on its tread (4) and/or wheel flange (5),
wherein the laser source has a scanning device for scanning the laser beam in order to ensure a constant distance between the surface of the wheel disk (1) to be machined by the laser beam and the laser source during a rotation of the wheel disk (1) around its axis of rotation (6), and
wherein a control unit is provided that comprises a data memory with control data for modulating the laser beam.

13. The apparatus for laser hardening of claim 12, wherein the data memory comprises rotation-related data sets of control data for modulation of the laser beam, such as, in particular, power of the laser beam, power distribution within the laser beam, laser focal width, scanning speed, scanning pattern of the laser-spot size or laser process time.

14. A railroad wheel, manufactured according to the method of claim 1, the tread (4) and wheel flange (5) of which are hardened over the full circumference at least in a partial width of tread (4) and/or wheel flange (5) by laser heat treatment, wherein the treated surface comprises, at its beginning and its end as well as after each full wheel revolution, a narrow overlap zone (8) with reduced laser power.

15. The railroad wheel of claim 14, wherein a width of the overlap zone (8) is approximately between ¼ and ⅛ of a track width of the treated surface.

16. The railroad wheel of claim 15, wherein the width of the overlap zone (8) is approximately ⅙ of the track width of the treated surface.
